(19) United States
(12) Patent Application Publication
(10) Pub. No.: US 2021/0221502 A1
(43) Pub. Date: Jul. 22, 2021

(54) METHOD AND A SYSTEM FOR REAL-TIME DATA PROCESSING, TRACKING, AND MONITORING OF AN ASSET USING UAV

(71) Applicant: ACTIVA INNOVATIONS SOFTWARE PRIVATE LIMITED, Fremont, CA (US)

(72) Inventor: Mahesh Godi, Fremont, CA (US)

(21) Appl. No.: 16/989,890

(22) Filed: Aug. 11, 2020

(30) Foreign Application Priority Data
Aug. 14, 2019 (IN) 201941032824

(51) Int. Cl. B64C 39/02; H04W 4/40; G06T 1/00; G06T 15/00

(52) U.S. Cl. CPC B64C 39/024; H04W 4/40; B64C 2201/146; G06T 15/00; G06T 2200/04; G06T 1/0007

(57) ABSTRACT

The present invention discloses a novel system and a method for providing real-time long-range connectivity between a UAV and a ground controller. This technology opens the door to a range of new UAV/drone based applications that have not been possible until now. The present invention discloses a technique to control the UAV using a user device by using a high speed long distance communication techniques.

### FIELD OF THE INVENTION

Embodiments of the present invention in general, concern a system, apparatus, and method for controlling of Unmanned Aerial Vehicle (UAV). More particularly, embodiments of the present invention concern to a system, apparatus, and method for controlling of Unmanned Aerial Vehicle (UAV) using cellular network.

### BACKGROUND OF THE INVENTION

In the recent years, the concept of the pilotless flying objects also known as Unmanned Aerial Vehicle (UAV) or drones has emerged. These pilotless flying objects (i.e. UAVs) are being used into variety of applications ranging from remote sensing, product delivery, remote surveillance, military purposes, agriculture, construction industry, medicine/organ delivery, search & rescue operations, fire monitoring, law and enforcement, and other related tasks.

In the existing prior art, it is known to incorporate in UAVs an imaging unit (e.g. camera) which is configured to capture the images of the target areas of interest. Also, it is known to navigate the drone remotely using short range communication techniques using radio frequency. However, already known techniques to navigate the UAV are inconvenient and inefficient, as the UAV can be navigated to a limited distance (e.g. line of sight). Also, the existing techniques know in the prior art does not provide a solution to share the UAV captured images in real-time over a cloud-based storage.

Currently, UAVs are controlled by utilizing a direct radio link with a pilot ground station.

Another shortcoming of the prior art techniques is that the images and videos recorded by the drones are stored in the memory of the drones, which can be accessed using the end user devices only after the flight path is over. Further, the data recorded by the drones is accessed and displayed on the conventional display devices which does not offer rich visual experience to the viewer.

Therefore, the existing known UAVs and techniques to us the same fail to solve the aforementioned shortcomings and thus a need exist in the domain to provide an improved UAV, and a system and a method to control the UAV which solve the above-mentioned problems.

Applicant has devised, tested and embodied the present invention to address the aforementioned and other many problems of the already known prior art systems and devices.

### SUMMARY OF THE INVENTION

It is an object of the present invention to address the problems associated with the prior art techniques, and a novel system and a method for providing real-time long-range connectivity between a UAV and a ground station. This technology opens the door to a range of new UAV/drone applications that have not been possible until now.

It is another object of the present invention to control the UAV using the user device using the cellular communication capabilities, wherein the cellular communication can be such as, and without limitation, GSM, 2G, 3G, UMTS, EDGE, GPRS, 4G, LTE, and/or 5G communication techniques.

It is another object of the present invention to provide a system and a method to generate real-time UAV based three-dimensional (3D) models of an asset (e.g. construction sites, industrial sites, power plants, residential buildings, natural structure, house, multi-storey building, machinery, etc.).

It is another object of the present invention to provide an UAV having a cellular communication capability, wherein the cellular communication capability is provided using an E-SIM or regular/standard SIM incorporated within the UAV.

It is another object of the present invention to utilize cellular network as a high bandwidth datalink to provide increased operational range and control the UAV automatously from a long-distance ground station.

It is another object of the present invention to provide Real Time Transfer of data collected from UAV to cloud computing infrastructure using cellular network (e.g. 2G/3G/4G/5G). Using the cellular network as a high bandwidth datalink will provide increased operational range for many applications such as UAV surveillance, delivery, search and rescue and emergency response flights in both urban and rural areas.

It is another object of the present invention to provide over the cloud real-time rendering of UAV collected data into 3D models using high-end Distributed Cloud Computing Platform using GPU/CPU and Graphics cards.

It is another object of the present invention to provide real-time UAV Data transfer from cloud to user devices.

It is another object of the present invention to render Real-time UAV collected data to 3D/4D format, and providing the rendered 3D/4D data to one or more of XR (extended reality) devices, VR (virtual reality) devices, MR (mixed reality devices), AR (augmented reality) devices, Mobile, PC, laptop, and/or tablets over a secure communication network.

It is another object of the present invention to provide an apparatus, a system, and a method to facilitate real-time inspection of transmission towers, wind turbines, real time monitoring status of agriculture crops, real time information on status of highways and railway tracks, and/or real-time tracking of spread of forest fires by controlling UAVs over cellular network.

It is another object of the present invention to provide a system and a method to facilitate real-time 3D mapping and active survey of an asset using Lidar (light Detection and ranging).

It is another object of the present invention to provide a system and a method to facilitate real-time radiation imaging of plants using UAVs e.g. Nuclear power plants.

It is another object of the present invention to provide a system and a method to facilitate real-time Photogrammetry images which are stitched together to make the orthophoto and to capture enough angles of each feature to model it in three-dimensions (3D).

It is another object of the present invention to provide an apparatus, a system, and a method which utilizes real-time Hyperspectral imaging sensors for tracking moving targets.

It is another object of the present invention to provide an apparatus, a system, and a method to facilitate generation of real-time surface models—Digital Elevation Models (DEM), Digital Surface Models (DSM), Digital Terrain Models (DTM), and Triangular Irregular Networks (TIN).

It is another object of the present invention to provide an apparatus, a system, and a method to facilitate generation of geospatially corrected aerial images (Orthophotography).

It is another object of the present invention to provide an apparatus, a system, and a method to facilitate creation of real-time 3D land modelling.

It is another object of the present invention to provide an apparatus, a system, and a method to facilitate creation of real-time 3D Building Models.

It is another object of the present invention to provide an apparatus, a system, and a method to facilitate generation of real-time contour maps.

It is another object of the present invention to provide an apparatus, a system, and a method to facilitate generation of real-time planemetric features (road edges, heights, signs, building footprints, etc.).

It is another object of the present invention to provide an apparatus, a system, and a method to facilitate generation of real-time volumetric surveys.

It is another object of the present invention to provide an apparatus, a system, and a method to enable streaming of data from UAVs in real time for quick analysis of the data to give instant results as compared to conventional methods. Real time analytics powered by Machine Learning and Artificial Intelligence can generate actionable intelligence to enable enterprises and security forces to respond to emergencies.

Various objects, features, aspects, and advantages of the present disclosure will become more apparent from the following detailed description of preferred embodiments, along with the accompanying drawing figures in which like numerals represent like features. The drawings illustrate exemplary embodiments of the present disclosure and, together with the description, serve to explain the principles of the present disclosure.

The foregoing summary is provided to introduce a selection of concepts in a simplified form that are further described below in the Detailed Description. This Summary is not intended to identify key features or essential features of the present invention, nor is it intended to be used to limit the scope of the subject matter.

Various objects, features, aspects and advantages of the inventive subject matter are described herein in connection with the following description and the annexed drawings. These aspects are indicative of various ways which can be practiced, all of which are intended to be covered herein. Other advantages and novel features may become apparent from the following detailed description when considered in conjunction with the drawings.

### BRIEF DESCRIPTION OF DRAWINGS

The diagrams are for illustration only, which thus is not a limitation of the present disclosure, and wherein:

FIG. 1A is an exemplary illustration of a real-time UAV data streaming system utilizing cellular network, according to an embodiment of the present invention;

FIG. 1B is an exemplary block diagram of an unmanned aerial vehicle (UAV) and its various sub-components, according to an embodiment of the present invention;

FIG. 2 is an exemplary illustration of a 3D model generation system of an asset by utilizing one or more UAVs, according to another embodiment of the present invention;

FIG. 3 is an exemplary flowchart illustrating Real time rendering of data into 3D models by utilizing one or more cellular capability based UAV and cloud computing, according to an embodiment of the present invention; and

FIG. 4 is an exemplary flowchart illustrating a method for providing an extended reality environment of an asset, according to an embodiment of the present invention.

### DETAILED DESCRIPTION OF DRAWINGS

Although the disclosure hereof is detailed and exact to enable those skilled in the art to practice the invention, the physical embodiments herein disclosed merely exemplify the invention which may be embodied in other specific structure.

Various aspects of this disclosure are now described with reference to the drawings, wherein like reference numerals are used to refer to like elements throughout. In the following description, for purposes of explanation, numerous specific details are set forth in order to provide a thorough understanding of one or more aspects. It should be understood, however, that certain aspects of this disclosure may be practiced without these specific details, or with other methods, components, materials, etc. In other instances, well-known structures and devices are shown in block diagram form to facilitate describing one or more aspects.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches also can be used.

In addition, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

As used in this application, the terms “system,” “platform,” “engine,” “controller,” “processor,” “processing unit,” “solution,” are intended to refer to a computer-related entity or an entity related to, or that is part of, an operational apparatus with one or more specific functionalities, wherein such entities can be either hardware, a combination of hardware and software, software, or software in execution. For example, an engine can be, but is not limited to being, a process running on a processor, a hard disk drive, multiple storage drives (of optical or magnetic storage medium) including affixed (e.g., screwed or bolted) or removable affixed solid-state storage drives; an object; an executable; a thread of execution; a computer-executable program, and/or a computer. By way of illustration, both an application running on a server and the server can be an engine. One or more instructions and/or computer program product can reside within a process and/or thread of execution, and an instructions and/or computer program product can be localized on one computer and/or distributed between two or more computers. Also, instructions and/or computer program product as described herein can execute from various computer readable storage media having various data structures stored thereon. The instructions and/or computer program product may communicate via local and/or remote processes such as in accordance with a signal having one or more data packets (e.g., data from one component interacting with another component in a local system, distributed system, and/or across a network such as the Internet with other systems via the signal). As another example, an engine and/or platform can be an apparatus with specific functionality provided by mechanical parts operated by electric or electronic circuitry which is operated by a software or a firmware application executed by a processor, wherein the processor can be internal or external to the apparatus and executes at least a part of the software or firmware application. As yet another example, an engine and/or platform can be an apparatus that provides specific functionality through electronic components without mechanical parts, the electronic components can include a processor therein to execute software or firmware that provides at least in part the functionality of the electronic components. As further yet another example, interface(s) can include input/output (I/O) components as well as associated processor, application, or Application Programming Interface (API) components.

The terms “UAV”, “drone”, and/or “flying objects” and the plural form of these terms are used interchangeably throughout the specifications to refer to a specific hardware, software, and/or a combination thereof which is designed and configured to perform various steps of real-time data streaming according to method(s) as described in the present invention.

Any, or any combination, of the preferable or essential features defined in relation to any one aspect or embodiment of the invention may be applied to any other aspect or embodiment of the invention wherever practicable.

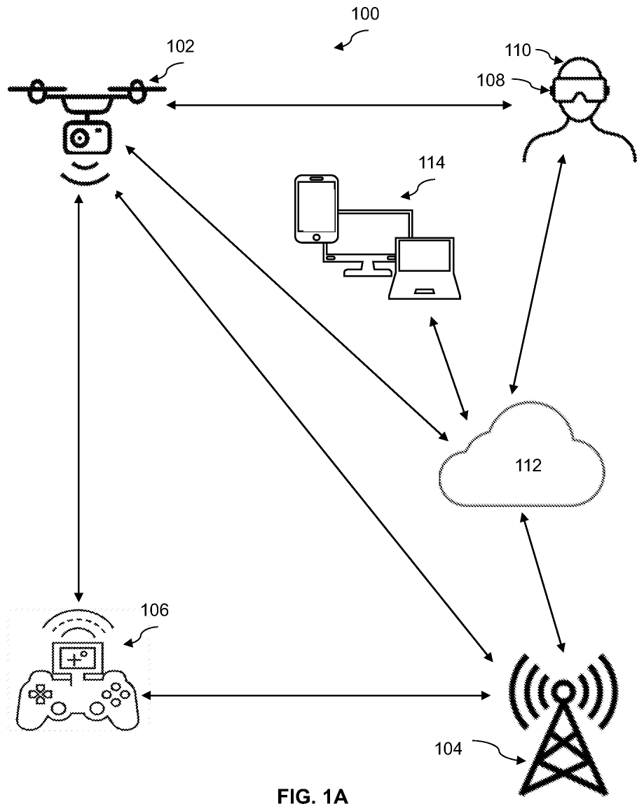

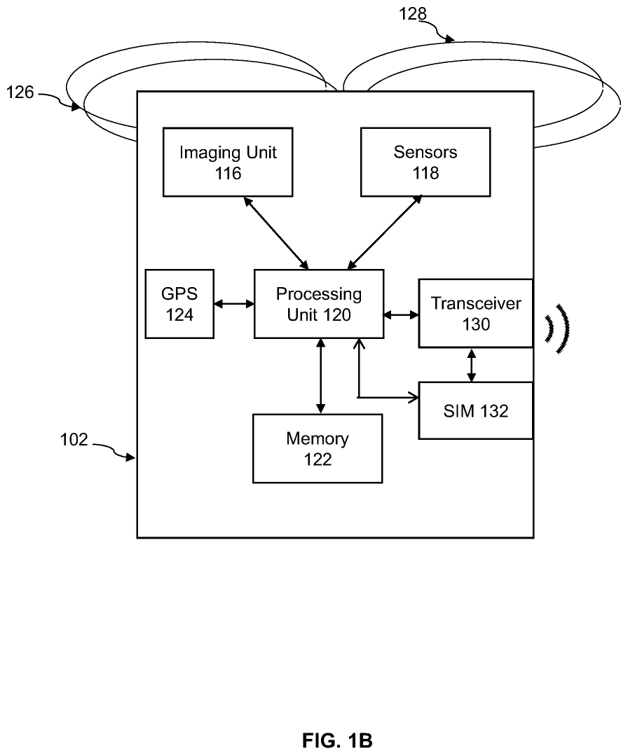

FIG. 1A illustrates an exemplary environment 100 where various embodiments of the present invention are implemented. The environment 100 includes a UAV (Unmanned Aerial Vehicle) 102, a communication network 104, a ground control station 106, one or more users 110 wearing Extended Reality (XR) Devices 108, and one or more end user devices 114. The environment 100 also comprises a cloud infrastructure 112, which can be accessed by various devices using the communication network, wherein the communication network may include, but is not restricted to, a communication network such as Internet, Intranet, PSTN, a cellular network, Local Area Network (LAN), Wide Area Network (WAN), Metropolitan Area Network (MAN), and so forth.

Examples of the end user devices 114 may include, but are not restricted to, a desktop computer, a laptop, a mobile/cell phone, a smart phone, a personal digital assistant (PDA), a tablet computer, smart-glasses, smartwatch, and the like.

The ground control station 106 may include at least a remote controller for controlling the functionality of the UAV 102, wherein the remote controller can be configured to communicate with the UAV 102 by using the communication network 104. According to preferred embodiment of the present invention, the remote controller is configured to communicate with the UAV 102 using the cellular network (e.g. 2G, 3G, UMTS, LTE, 4G, EDGE, GPRS, 5G, etc.). More specifically, the remote controller 106 may be provided with a cellular communication capabilities by using for example, a cellular communication module. In an embodiment, the cellular communication module can be a regular SIM (subscriber identity module) and/or a E-SIM. Further, the remote controller 106 may be provided with a display unit.

In an embodiment, a mobile phone or other similar end user devices may be configured to perform the functionality of the remote controller. According to yet another embodiment, the user 110 using the extended reality device 108 may be configured to transmit the navigational and UAV control information to the UAV 102 by using the remote controller 106, the mobile phone, or other similar end user devices 114.

As shown in FIG. 1B, the UAV 102 comprises one or more imaging units 116, wherein the imaging unit is configured to capture pictures (e.g. visual feed) of various objects of interest. In an embodiment, the objects of interest are identified and provided to UAV 102 with the help of ground control station 106. In another embodiment, the UAV 102 is programmed to automatically identify the objects of interests using specially designed artificial intelligence & machine learning techniques. In an embodiment, the UAV 102 further comprises one or more sensors 118 to acquire one or more parameters of interest. For example, the sensors 118 can be temperature sensors, infrared (IR) sensors, humidity sensor, IR camera, seismic sensors, radiation detectors, ultrasound telemetary sensors, thermal sensors, motion sensor, accelerometer vibration sensor, optical sensor, photosensitive sensor, chemical sensors, speedometer, pressure sensor, altimeter, Radar, Lidar, etc. These sensors 118 are configured to detect parameters such as, but not limited to, weather conditions, vibrations, ambient temperature, motion, heat, corrosion, and so forth.

The UAV 102 further comprises a processing unit 120 which may be specially designed and configured to facilitate the execution of various UAV functions as per one or more instructions programmed in a memory 122 of the UAV 102.

The UAV 102 may also comprise a global position system (GPS) 124 which is used to determine the accurate position related information of the UAV 102. The processing unit 120 of the UAV 102 may be configured to receive data from various sensors 118 (e.g. accelerometer, altimeter, imaging unit, IR sensor, optical sensor, etc.) to operate the UAV 102 in a desired speed, altitude, and/or orientation, and to thereby perform various desired functionalities. In an embodiment, the desired functionalities can be such as, and without limitation, monitoring functions, surveillance, radiation sensing, etc.

The UAV 102 also comprises one or more propellers (126, 128) positioned around the body of the UAV 102, wherein the processing unit 120 is configured to control parameters such as speed and/or rotation of the propellers (126, 128) movement to control the movement of the UAV 102 in the air. The propellers (126, 128) are configured to provide the both horizontal thrust as well as the vertical thrust to the UAV 102. In an embodiment, the UAV 102 may be configured to receive control parameters from a ground control station 106 over the communication network 104. In another embodiment, the UAV 102 is configured to automatically learn the control parameters on the basis of data input by the one or more sensor. In other words, the UAV 102 may be configured to operate in the auto-pilot mode.

In an embodiment, the UAV 102 comprises long-distance wireless communication capabilities, wherein the long-distance wireless communication capabilities include wi-fi, cellular communication, etc. The UAV 102 may also include a subscriber identity module (SIM) 132, for example, E-SIM or regular-SIM, to enable the long-distance wireless communication capabilities.

Further, UAV 102 is provided with wireless communication capabilities, wherein the UAV 102 comprises a transceiver 130 to communicate with one or more devices using the communication network 104, wherein the one or more devices can be, for example and without limitation, remote controller 106, cloud computing infrastructure 112, one or more end user devices 114, and/or one or more extended reality (XR) devices 108.

The data recorded by the UAV 102 may be transmitted in real-time to one or more devices over the communication network using the long-distance wireless communication capabilities.

In an embodiment, the UAV 102 is configured to capture audio, video, images, and/or other sensor capture data, the captured data is streamed in real-time to cloud computing infrastructure 112 or web. In another embodiment, the UAV 102 is configured to capture audio, video, images, and/or other sensor capture data, the captured data is streamed in real-time to client premises system for further processing of the data.

Further, the end user devices 114 and/or Extended Reality (XR) devices 108 may be configured to access the cloud and/or on premises stored data securely. For example, the data stored over the web or cloud computing infrastructure 112 can be accessed by a user by using the end user device 114 by providing valid login credentials, therefore the users having access rights can access the UAV 102 captured data.

In an embodiment, the extended reality devices 108 may be provided with a cellular communication capabilities by using for example, a cellular communication module. In an embodiment, the cellular communication module integrated within the extended reality devices 108 can be a regular SIM (subscriber identity module) and/or a E-SIM. For many applications described herein, the UAV 102 may be controlled by the user 110 by using the extended reality device 108 by using the cellular communication capabilities. The extended reality device 108 may also be provided with a processing unit (not shown), a memory, one or more sensors, and/or a transceiver to communicate with the remote UAV 102, the remote controller 106, the end user devices 114, and/or the cloud processing environment 112. Further, the extended reality device 108 may also be provided with wireless communication capabilities using, for example, wi-fi.

In another embodiment, the data recorded by the UAV 102 is transmitted in real-time to cloud processing environment 112, wherein the received data is processed and rendered into 3D models by using high computing power distributed and parallel processing using a plurality of CPUs and/or GPUs. The cloud processing environment 112 is specially designed and configured to receive the data from one or more UAVs 102, and render the received data into 3D models and/or extended reality objects using high speed distributed and parallel processing.

According to an embodiment, the plurality of UAVs 102 are configured to operate in collaboration and capture a target asset information from different heights, angles, distance, and/or aspect ratio. According to this embodiment, the information received from the plurality of UAVs 102 is processed and stitched together by the cloud computing infrastructure 112, and a consolidated 3D model of the target asset is generated by the cloud computing infrastructure 112. In an embodiment, the UAV 102 is provided with object recognition capabilities.

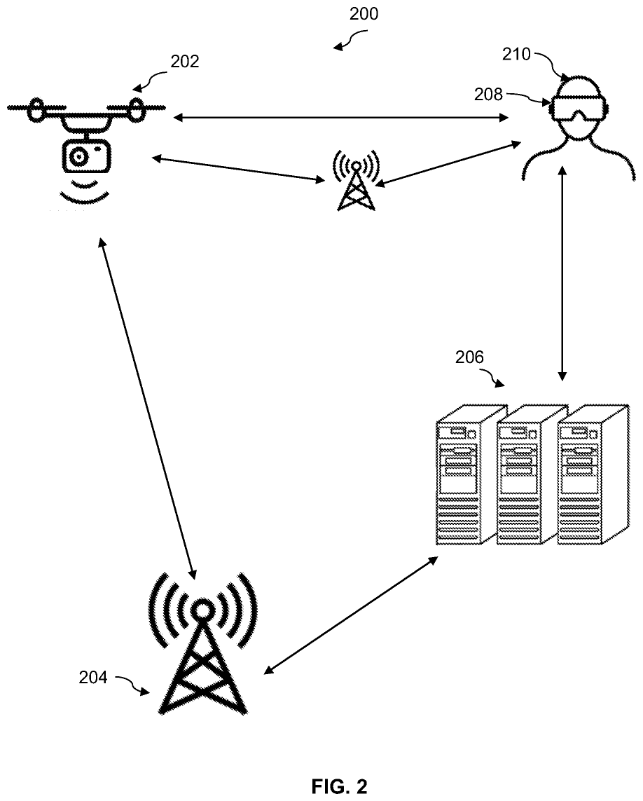

FIG. 2 illustrates a block diagram of an exemplary 3D model generation system 200 of an asset subject to survey by utilizing one or more UAVs, according to another embodiment of the present invention. In an embodiment, the asset can be such as, and without limitation, power plant, nuclear plant, construction site, industrial site, building, shopping mall, agriculture field, war zone, highway, railway track, runways, cell site, natural structure, etc.

The present invention illustrates a novel technique to render 3D models of the real-time UAV collected data of a target asset by using high-end distributed remote computing platform using GPUs, CPUs, and/or graphics cards. According to an embodiment, the remote computing platform may be a cloud based computing platform. In another embodiment, the remote computing platform may be deployed on the premises.

As shown in FIG. 2, the UAV 202 is programmed to navigate along the target asset and capture one or more images/videos related to regions of interest. In an embodiment, the UAV may be navigated using the remote controller 106. According to another embodiment, the user 210 using the extended reality device 208 may be configured to transmit the navigational and UAV control information to the UAV 102 by using the remote controller, the mobile phone, or other similar end user devices 114.

In an embodiment, the UAV 202 may be programmed to capture multimedia information related to target asset using the imaging unit 116. Further, the navigation and control information may be either programmed into the memory 122 of the UAV 202 or may be transmitted to the processing unit 120 of the UAV 202 by using the remote controller 106. In an embodiment, the UAV 202 may be programmed to operate in the autonomous autopilot mode, wherein the UAV 202 may be programmed to learn the flight parameters on the basis of the case scenario. In an embodiment, the UAV 202 may be provided with the artificial intelligence and/or machine learning capabilities by suitably trained algorithms and the hardware devices. In another embodiment, the UAV 202 may be navigated using a remote controller (106 as shown in FIG. 1). In yet another embodiment, the UAV 202 may be navigated by using the extended reality device 102 along with the remote controller.

The data captured by UAV 202 may be further transmitted to a remote server 206, wherein the data captured by the UAV 202 is transmitted by using a cellular network 204. The UAV 202 may include a transceiver 130 and a Subscriber Identity Module 132 which are configured to enable the long range cellular communication capabilities within the UAV 202. Therefore, UAV 202 as described in the present invention is provided with real-time high-speed data transmission capabilities by using the cellular network 204.

The present invention illustrates a novel and specially programmed remote server which is configured to render 3D models of the real-time UAV collected data of a target asset by using high-end distributed remote computing platform using GPUs (Graphical Processing Units), CPUs (Central Processing Units), and/or graphics cards. According to an embodiment, the remote server 206 may be a cloud based computing platform. In another embodiment, the remote server may be deployed on the client premises.

The remote server 206 may comprise one or more processing devices and may be configured to render 3D models of the data captured by the UAV of the target asset. In an embodiment, the received data, which is captured by the UAV 202, is processed by the one or more processing devices of the remote server 206 to recognize the target asset. For example, the UAV recorded data is processed in real-time by the remote server 206 by using distributed and parallel processing to classify the various objects in the captured images.

Once the target asset is recognized by the remote server 206, a computer aided design (CAD) and/or computer aided motion (CAM) data is fetched of the target asset by the remote server 206. The remote server 206 is also programmed to compare the data captured by the UAV 202 and the computer aided design and/or the computer aided motion (CAM) data to determine the dynamic changes (e.g. work progress) occurring over the target asset.

The remote server 206 is further programmed to generate extended reality (XR) based objects based on the rendered 3D model of the target asset, wherein the generated XR objects are provided to one or more users by using the extended reality (XR) device 208 worn by the users 210. Thereby, rich visual experience may be provided to the user 210 to analyze the state of the target asset. In an embodiment, the remote server 206 is configured to transmit the rendered 3D model of the target asset to the extended reality (XR) device 208, wherein the extended reality (XR) device 208 is configured to generate the corresponding extended reality (XR) based view for the user 210 by processing the received 3D model. The extended reality (XR) device 208 is configured to processes the spatial data and maps to relevant 3D models that are then superimposed on users view of real world.

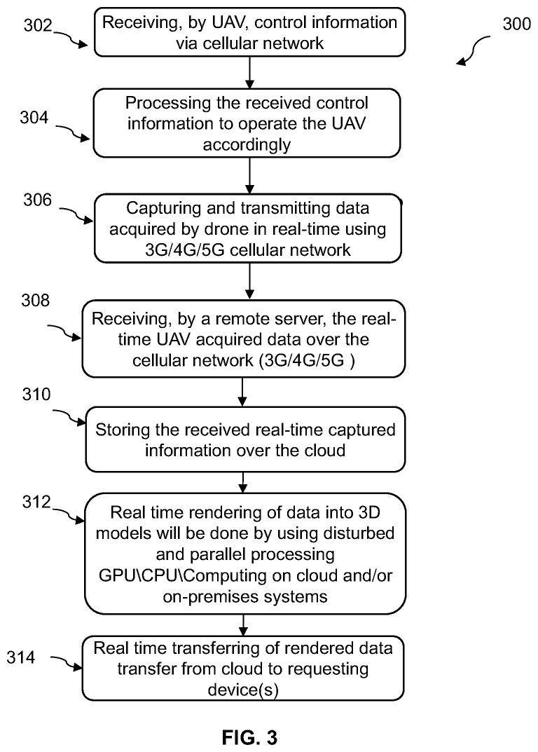

FIG. 3 illustrates a flow diagram 300 of a method for rendering 3D models of a target asset that is being surveyed by a UAV 102, according to an aspect of the present invention. The present invention enables real-time tracking of a target asset by using real-time data streaming from a UAV 102 by using long distance cellular communication capabilities. In an embodiment, the target asset can be such as, and without limitation, a construction site, industrial site, power plant, residential building, natural structure, apartment, house, nuclear plant, commercial building, multi-storey building, and/or a shopping complex.

The process begins at step 302, when a control information is received, by a processing unit of the UAV 102 via a communication network 104 from a remote-control station 106. In an embodiment, the communication network 104 is a cellular network (e.g. 3G/4G/5G). Also, the remote-control station 106 may include a user device (e.g. UAV remote controller or a mobile device) which is programmed to transmit flying, navigation, and/or data recording instructions to the UAV 102. In an embodiment, the UAV 102 may be programmed to operate in the auto-pilot mode, and programmed to autonomously operate and sense the desired information.

In step 304, the processing unit of the UAV 102 is programmed to analyze the received control information, and identifies the desired maneuver and/or desired actions that the UAV needs to perform, wherein the desired actions may include flying in particular height, speed, controlling rotation, data recording, image capturing, video recording, etc. In an embodiment, when the control instructions are received by the processing unit 120 of the UAV 102, the processing unit 120 is configured to control one or more propellers (126, 128), sensors 118, and/or imaging units 116 of the UAV 102 to perform the desired functions. In an embodiment, UAV 102 may be controlled to capture video, images, audio, environmental parameters, weather conditions, etc. In another embodiment, the UAV 102 may be controlled to capture real-time video/images of the target asset (e.g. industrial site construction site, multi-storey building, etc.).

In step 306, the data acquired by the UAV 102 is transmitted in real-time by using high speed cellular network 104. For example, the data acquired by the UAV 102 is streamed in real-time to one or more computing devices for further analysis and processing. In another embodiment, the data acquired by the UAV 102 is streamed in real-time to one or more extended reality (XR) devices 108.

In step 308, a remote server is configured to receive the data acquired by the UAV 102 in real-time. In an embodiment, the data acquired by the UAV 102 is transmitted directly to the remote server (e.g. 206) by using the high-speed cellular communication network.

In step 310, the data acquired by the UAV 102 is streamed in real-time and stored over a cloud computing infrastructure 112. According to an embodiment, the remote server (e.g. 206) may be configured to access the web or cloud computing infrastructure by using the communication network 104.

In step 312, a 3D model rendering of the data captured by the UAV 102 is done by using distributed and parallel processing. In an embodiment, the distributed and parallel processing of the UAV captured data is performed by using one or more processing devices (e.g. CPU/GPU) on cloud computing environment and/or on-premises systems.

The rendered 3D model of the target asset is thereafter transmitted to one or more end user devices 114 and/or XR (extended reality) devices 108 for display and further analysis, as depicted in next 314. The data stored over the cloud computing infrastructure 112 is transmitted to requesting end user devices 114. In one embodiment, the end user devices 114 may access the rendered data from the cloud computing infrastructure 112 by providing valid login credentials. In another embodiment, the rendered 3D model data is transmitted in real-time to the requesting extended reality (XR) device 108.

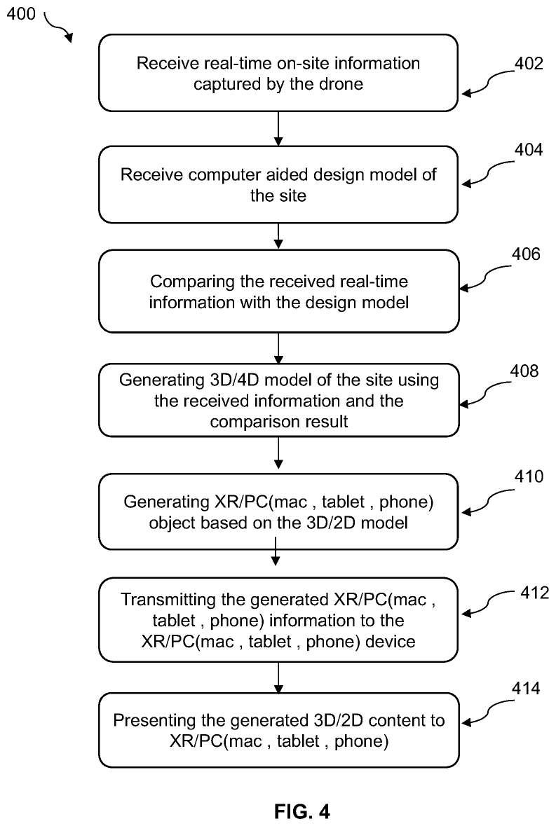

FIG. 4 illustrates a flow diagram 400 of a method for generating extended reality (XR) objects of a target asset surveyed by a UAV, according to an aspect of the present invention.

The process begins at step 402, wherein a remote server 206 is configured to receive a real-time information of the target asset being surveyed by one or more UAVs 202 (or UAV 102), wherein the remote server 206 is configured to provide the 3D/2D content to one or more end user devices 114 and/or XR devices 208 (or XR device 108). In an embodiment, the data recorded by the UAV 202 is transmitted to the remote server 206 by using the cellular communication network 204.

In an embodiment, the one or more end user devices 114 can be such as, and without limitation, a desktop computer, a laptop, a mobile/cell phone, a smart phone, a personal digital assistant (PDA), a tablet computer, a wearable device, a smartwatch, smart-glasses, virtual reality glasses, and the like. According to another embodiment, the remote server 206 may be a cloud based computing platform. In yet another embodiment, the remote server 206 may be deployed on the client premises.

In step 404, the remote server 206 is configured to receive the computer aided design (CAD) and/or the computer aided motion (CAM) associated with the target asset. In an embodiment, the CAD/CAM associated with the asset is stored and retrieved from a central storage location. In another embodiment, user may be provided an option to upload the computer aided design and/or the computer aided motion of the asset. In yet another embodiment, the remote server 206 may be configured to store computer aided design of the target asset.

According to an exemplary embodiment, when the remote server 206 receives a UAV captured data of the target asset, the one or more processing devices of the UAV may be programmed to compare the captured images and/or one or more sensor information (position information, location information, weather data, environmental features, etc.) to identify the computer aided design (CAD) and/or computer aided motion (CAM) associated with the target asset.

Thereafter In step 406, when the computer aided design (CAD) and/or computer aided motion (CAM) has been received by the remote server 206 by using the one of the aforementioned technique, the one or more processing devices of the remote server 206 may be programmed to compare the received real-time UAV captured information with the design/motion data associated with the target asset.

In step 408, one or more processing devices of the remote server 206 are configured to generating 3D/4D model of the target asset using the received information and the comparison result. According to an embodiment, the remote server 206 may be configured to receive real-time target asset information from a plurality of UAVs 202, wherein the plurality of UAVs 202 are configured to operate in collaboration and capture the target asset information from different heights, angles, distance, and/or aspect ratio. According to this embodiment, the information received from the plurality of UAVs 202 is processed and stitched together by the remote server 206, and a consolidated 3D model of the target asset is generated by the remote server 206. According to an embodiment, the remote server 206 may be provided real-time analysis of the UAV captured data, for example, the remote server 206 may be configured to check problems (e.g. detects, breakage, corrosion, etc.) related to the target asset. In an exemplary embodiment, the remote server 206 may be programmed to compare the target asset information captured by one or more UAVs 202 with historically stored information to determine the problems related to the target asset, wherein the historical information may be related to various problems that the target asset may be vulnerable to. For determining the problem related to the target asset, the result of the comparison may be matched with a threshold value, wherein the asset is determined to have a particular defect when the comparison value increases the threshold value.

Further, in step 410, the remote server 206 is programmed to generate extended reality (XR) objects for device 108, and/or end user devices 114 (mac, tablet, and/or phone) based on the generated 3D model.

In step 412 and 414, the extended reality (XR) objects generated by the remote server 206 corresponding to the target asset are transmitting to the generated XR device 108, and/or end user devices 114 (mac, tablet, and/or phone). Thereafter, in step 414, the generated extended reality (XR) objects are presented to the user by using the extended reality (XR) device 208/or end user device 114 (mac, tablet, and/or phone). For doing this, the extended reality (XR) device 208 is configured to receive the transmitted extended reality (XR) objects by using a transceiver. In an embodiment, the transceiver is provided with wireless communication capability (e.g. cellular communication). Once the extended reality (XR) objects are received, those are processed by using the processing unit of the extended reality device 208 to decode and/or regenerate the transmitted information. Finally, the processing unit of the extended reality device 208 is configured to transmit the processed information to the display to present the regenerated extended reality objects to the user 210. While the extended reality objects are generated by the cloud computing infrastructure 112 and/or remote server 206 according to the exemplary embodiment of the present invention, however, it should be noted that the extended reality device 108 may also be suitably programmed to receive the 3D model of the UAV captured information from the cloud computing infrastructure 112 and generate the corresponding extended reality based visualization (XR objects) for the display to the user 110. In an embodiment, the extended reality objects are the visualization of the 3D model of the UAV captured information in the extended reality.

Therefore, the present invention provides a unique and novel technique to generate real-time 3D model of target asset by using the UAV captured information of the target asset. Consequently, the present invention can be utilized to determine state of the target asset by using the UAV, for example, the present invention may be utilized to determine defects (e.g. corrosion, breakage, etc.) related to the target asset. Further, the present invention provides a unique technique of 3D mapping of the target asset, and performing real-time analysis of the target asset by using Extended Reality technique. In effect, the present invention may be used for the remote long-distance surveillance of the target asset by using techniques such as extended reality, UAV, cellular communication, cloud computing, and/or 3D modelling. Moreover, the present invention provides a real-time bird's eye 3D view of a target asset, captured by one or more UAVs, by using the extended reality technique.

While the disclosed embodiments of the subject matter described herein have been shown in the drawing and fully described above with particularity and detail in connection with several exemplary embodiments, it will be apparent to those of ordinary skill in the art that many modifications, changes, and omissions are possible without materially departing from the novel teachings, the principles and concepts set forth herein, and advantages of the subject matter recited in the appended claims. Hence, the proper scope of the disclosed innovations should be determined only by the broadest interpretation of the appended claims so as to encompass all such modifications, changes, and omissions. In addition, the order or sequence of any process or method steps may be varied or re-sequenced according to alternative embodiments.

What is claimed is:

1. A system comprising:
an unmanned aerial vehicle (UAV) having cellular communication capabilities;
a remote controller with cellular communication capabilities capable of communicating with the unmanned aerial vehicle (UAV) by using a cellular network;
a remote server; and
an extended reality device;
wherein the unmanned aerial vehicle (UAV) is configured to capture information on the basis of information received from the remote controller, and transmit the captured information to the remote server over the cellular network,
wherein the remote server is configured to render the unmanned aerial vehicle (UAV) captured information into three-dimensional (3D) model, and
wherein the extended reality device is configured to present the three-dimensional (3D) model of the unmanned aerial vehicle (UAV) captured information in the extended reality environment.

2. The system of claim 1, wherein the cellular network is one or more of a GSM network, 2G-network, 3G-network, 4G-network, and 5G-network.

3. The system of claim 1, wherein the remote server is configured to render the unmanned aerial vehicle (UAV) captured information in real-time into three-dimensional (3D) model by using high-end distributed computing via one or more graphical processing units (GPUs) and/or central processing units (CPUs)

4. The system of claim 1, wherein the remote server is implemented in a cloud computing infrastructure or at client premises.

5. The system of claim 1, wherein the extended reality device is configured to present the three-dimensional (3D) model of the unmanned aerial vehicle (UAV) captured information in the extended reality environment in real-time.

6. The system of claim 1, wherein the cellular communication capabilities in the unmanned aerial vehicle (UAV) and/or the remote controller are provided by using an embedded subscriber identity module (eSIM) or a standard subscriber identity module (standard SIM).

7. The system of claim 1, wherein the remote controller functionalities of controlling the unmanned aerial vehicle (UAV) are performed by using the extended reality device having cellular communication capabilities, wherein the cellular communication capabilities are provided in the extended reality device by using an embedded subscriber identity module (eSIM) or a standard subscriber identity module (standard SIM).

8. The system of claim 1, wherein the unmanned aerial vehicle (UAV) further comprises:
an imaging unit to capture one or more images and/or videos;
one or more sensors provided to sense at least environmental information and/or unmanned aerial vehicle (UAV) parameters;
an embedded subscriber identity module (eSIM) or a standard subscriber identity module (standard SIM);
a transceiver configured to enable long range cellular communication capabilities by using the subscriber identity module; and
a processing unit configured to execute one or more instructions stored in a storage device to perform various unmanned aerial vehicle (UAV) functionalities.

9. The system of claim 1, wherein the remote server is configured to render in real-time the unmanned aerial vehicle (UAV) captured information into three-dimensional (3D) model by using computer aided design information of an asset.

10. A method comprising;
transmitting, by a remote controller, control information over the cellular network to an unmanned aerial vehicle, wherein the control information comprises at least information to optimize movement of the unmanned aerial vehicle and/or information to capture one or more areas of interest;
capturing, by the unmanned aerial vehicle, images of one or more areas of interest in accordance to the control information provided by the remote controller over the cellular network;
transmitting, by the unmanned aerial vehicle, the captured images of one or more areas of interest to a cloud computing infrastructure over the cellular network;
rendering in real-time, by the cloud computing infrastructure, three-dimensional (3D) model of the images captured by the unmanned aerial vehicle by using distributed and parallel processing using a plurality of central processing units (CPUs) and/or graphical processing units GPUs; and
transmitting, by the cloud computing infrastructure, the rendered three-dimensional (3D) model to an extended reality device; and
generating and displaying in real-time, by the extended reality device, extended reality based visual representation of the rendered three-dimensional (3D) model to a user.
